(19) United States
(12) Patent Application Publication
(10) Pub. No.: US 2013/0291990 A1
(43) Pub. Date: Nov. 7, 2013

(54) DUCT INSULATION LAMINATES AND METHODS OF MANUFACTURING AND INSTALLATION

(71) Applicant: OWENS CORNING INTELLECTUAL CAPITAL, LLC, Toledo, OH (US)

(72) Inventors: Venkata S. Nagarajan, New Albany, OH (US); Daphne Haubrich, Markelo (NL); Jerry M. Parks, Granville, OH (US); Neil Hettler, Granville, OH (US); Weigang Qi, Westerville, OH (US); William Kunkler, Heath, OH (US)

(73) Assignee: OWENS CORNING INTELLECTUAL CAPITAL, LLC, Toledo, OH (US)

(21) Appl. No.: 13/770,000

(22) Filed: Feb. 19, 2013

Related U.S. Application Data
(60) Provisional application No. 61/641,492, filed on May 2, 2012.

(51) Int. Cl. F16L 9/21; B32B 5/26; B32B 5/24; B32B 37/00; B32B 9/00; B32B 7/14; B32B 3/04; B32B 27/06; B32B 5/02; B32B 3/12

(52) U.S. Cl. CPC F16L 9/21; B32B 5/028; B32B 5/022; B32B 5/26; B32B 5/245; B32B 3/12; B32B 9/002; B32B 7/14; B32B 3/04; B32B 27/065; B32B 37/00
USPC 138/140; 442/50; 442/54; 442/57; 442/56; 428/116; 428/196; 428/121; 156/60; 29/428; 181/286

(57) ABSTRACT

A duct insulation laminate an insulation layer and a facing. The insulation layer includes an insulation layer having a first edge surface, a second edge surface that is spaced apart from the first edge surface, a first face surface that extends from the first edge surface to the second edge surface, and a second face surface that is opposed to and spaced apart from the first face surface. The second face surface extends from the first edge surface to the second edge surface. The facing is attached to the first face surface, and includes a polyester blended non-woven veil defining an outermost exterior surface of the duct insulation laminate.

The present application claims priority to and the benefit of U.S. Provision Patent Application Ser. No. 61/641,492, filed on May 2, 2012, the entire disclosure of which is incorporated herein by reference in its entirety.

### BACKGROUND

Ducts and conduits are used to convey air in building heating, ventilation, and air conditioning (HVAC) systems. Often these ducts are formed of sheet metal, and, as a result, do not possess good thermal or acoustical properties. In order to enhance these properties, HVAC ducts may be provided with a flexible or rigid thermal and sound insulating material. In some applications, flexible wraps containing fibrous insulation materials (e.g., fiberglass) are wrapped around the exterior surfaces of a duct, for example, in a spiral configuration. In other applications, flexible fibrous insulation liners are applied to the internal surfaces of a duct (e.g., a cylindrical spiral metal duct). In still other applications, rigid insulating duct boards may be sized (e.g., cut or pre-formed) to be secured to internal or external surfaces of a square, rectangular, or spiral duct.

### SUMMARY

According to an exemplary embodiment of the present application, a duct insulation laminate an insulation layer and a facing. The insulation layer includes an insulation layer having a first edge surface, a second edge surface that is spaced apart from the first edge surface, a first face surface that extends from the first edge surface to the second edge surface, and a second face surface that is opposed to and spaced apart from the first face surface. The second face surface extends from the first edge surface to the second edge surface. The facing is attached to the first face surface, and includes a polyester blended non-woven veil defining an outermost exterior surface of the duct insulation laminate.

According to another exemplary embodiment of the present application, a duct assembly includes a duct housing having an interior surface and an exterior surface; and a duct insulation laminate secured to the interior surface of the duct housing. The duct insulation laminate includes an insulation layer and a facing. The insulation layer has a first edge surface, a second edge surface that is spaced apart from the first edge surface, a first face surface that extends from the first edge surface to the second edge surface, and a second face surface that is opposed to and spaced apart from the first face surface. The second face surface extends from the first edge surface to the second edge surface. The facing is attached to the first face surface and includes a polyester blended non-woven veil defining an outermost exterior surface of the duct insulation laminate. The duct insulation laminate is oriented such that the second face surface of the facing faces the interior surface of the housing.

In yet another exemplary embodiment, a method is contemplated for making a duct insulation laminate. In the method, an insulation layer is provided with a first edge surface, a second edge surface that is spaced apart from the first edge surface, a first face surface that extends from the first edge surface to the second edge surface, and a second face surface that is opposed to and spaced apart from the first face surface, with the second face surface extends from the first edge surface to the second edge surface. A facing is attached to the first face surface of the insulation layer to define an outermost exterior surface of the duct insulation laminate, with the facing including a polyester blended non-woven veil defining an outermost exterior surface of the duct insulation laminate.

In still another embodiment, a duct insulation laminate includes an insulation layer and a facing. The insulation layer includes a first edge surface, a second edge surface that is spaced apart from the first edge surface, a first face surface that extends from the first edge surface to the second edge surface, and a second face surface that is opposed to and spaced apart from the first face surface, with the second face surface extends from the first edge surface to the second edge surface. The facing is attached to the first face surface. The duct insulation laminate demonstrates a sound absorption coefficient from 400-1000 Hz of at least 20% greater than a corresponding sound absorption coefficient of the insulation layer without the facing.

### BRIEF DESCRIPTION OF THE DRAWINGS

Features and advantages of the present application will become apparent to those of ordinary skill in the art to which the application pertains from a reading of the following description together with the accompanying drawings, in which:

FIG. 1 is a graph illustrating sound absorption of exemplary duct insulation laminates;

FIG. 2 illustrates an end view of an exemplary embodiment of a duct insulation laminate;

FIG. 3 illustrates a perspective view of the duct insulation laminate illustrated by FIG. 2;

FIG. 3A illustrates a perspective view of material that may be cut to form duct insulation laminates rolled onto a roll;

FIG. 4 illustrates an end view of an exemplary embodiment of a duct insulation laminate;

FIG. 5 illustrates a perspective view of the duct insulation laminate illustrated by FIG. 4;

FIG. 6 illustrates a perspective view of an exemplary insulated duct assembly;

FIG. 7 illustrates a perspective view of another exemplary insulated duct assembly; and

FIG. 8 illustrates a perspective view of another exemplary insulated duct assembly.

### DETAILED DESCRIPTION

Prior to discussing the various embodiments, a review of the definitions of some exemplary terms used throughout the disclosure is appropriate. Both singular and plural forms of all terms fall within each meaning:

As described herein, when one or more components are described as being connected, joined, affixed, coupled, attached, or otherwise interconnected, such interconnection may be direct as between the components or may be indirect such as through the use of one or more intermediary components. Also as described herein, reference to a “member,” “component,” or “portion” shall not be limited to a single structural member, component, or element but can include an assembly of components, members or elements. “Physical communication” as used herein, includes but is not limited to connecting, affixing, joining, attaching, fixing, fastening, placing in contact two or more components, elements, assemblies, portions or parts. Physical communication between two or more components, etc., can be direct or indirect such as through the use of one or more intermediary components and may be intermittent or continuous.

In the embodiments discussed herein, the insulation arrangements of the present application are described for use with ducts. However, the insulation arrangements of the present application may be used in a variety of different applications. The present patent application specification and drawings provide multiple embodiments of insulation arrangements and duct assemblies. Any feature or combination of features from each of the embodiments may be used with features or combinations of features of other embodiments.

The present application describes duct insulation laminates utilizing a facing material secured to an insulation layer and configured to provide one or more enhanced properties for the resulting insulation laminate. Examples of enhanced properties that may be provided by the facing material include one or more of insulation particle containment, improved thermal insulation properties, improved acoustic insulation properties, improved fire resistant properties, and improved antimicrobial properties.

Properties of exemplary facing materials are listed in the table below. In one example, identified below as Example #1, the facing material is a nonwoven glass-polyester veil, including a mixture of approximately 50%-90% boron-free E and E-CR glass reinforcement fibers (e.g., Advantex® fibers, manufactured by Owens Corning) having a nominal length of approximately 10 mm and a nominal diameter of approximately 10 μm, and approximately 10%-50% polyester fibers. The exemplary mixture is bound by a binder with approximately 8%-30% modified polyvinyl alcohol and approximately 15%-45% latex, and the bound material is filled with approximately 40%-90% of an inorganic mineral filler to improve opacity and reduce porosity, including a flame retardant, surfactant and optical brightener.

Another exemplary facing material, identified below as Example #2, includes a nonwoven mixture of approximately 60%-95% boron-free E and E-CR glass reinforcement fibers having a nominal length of approximately 6 mm and a nominal diameter of approximately 10 μm, and approximately 5%-40% thin polyester fibers to provide a controlled and reduced porosity. The exemplary mixture is bound by a binder with approximately 8%-30% modified polyvinyl alcohol, treated with inorganic fillers and a flame retardant.

Still another exemplary facing material, identified below as Example #3, is a nonwoven veil including boron-free E and E-CR glass reinforcement fibers having a nominal length of approximately 10 mm and a nominal diameter of approximately 10 μm without polyester fibers. The fibers are bound by a binder with approximately 8%-30% modified polyvinyl alcohol, and treated with inorganic fillers and a flame retardant.

Yet another exemplary facing material, identified below as Example #4, is a nonwoven veil including approximately 20%-65% of a first type of boron-free E and E-CR glass reinforcement fibers having a nominal length of approximately 6 mm and a nominal diameter of approximately 10-11 μm, and approximately 35%-80% of a second type of boron-free E and E-CR glass reinforcement fibers having a nominal length of approximately 6 mm and a nominal diameter of approximately 6-7 μm. The fibers are bound by a binder with approximately 8%-30% modified polyvinyl alcohol, and treated with a flame retardant and aluminum trihydrate.

| | TEST | | | | | |
|---|---|---|---|---|---|---|
| PROPERTY | METHOD | UNITS | Example 1 | Example 2 | Example 3 | Example 4 |
| Area Weight | ISO 536 | g/m² | 195 | 75 | 120 | 180 |
| Tensile Strength | ISO 1924/2 | N/50 mm | >200 | >250 | >190 | >240 |
| md | | | | | | |
| Tensile Strength | ISO 1924/2 | N/50 mm | >180 | >230 | >170 | >260 |
| cd | | | | | | |
| Loss on Ignition | ISO 1887 | % | Not tested | 35 | 16 | 31 |
| Caliper | ISO 534 | mm | 0.34 | 0.68 | 0.5 | 0.58 |
| Porosity | DIN 53887 | l/m²/s | <300 | 1400 | <250 | <1000 |

As one example, a duct insulation laminate is provided with a facing material having a low air permeability or porosity, for example, to reduce the number of fibers or other particles released from the insulation layer into the duct passage (in the case of an internal duct liner) or into the environment surrounding the duct (in the case of an external duct wrap). For example, the facing material may have a porosity (per DIN 53887 testing) of less than approximately 1400 l/m²/s, or less than approximately 1000 l/m²/s, or less than approximately 300 l/m²/s.

As another example, a duct insulation laminate is provided with a facing material having a minimal thickness or caliper, for example, to provide sufficient flexibility when the facing material is laminated to a lofted insulation blanket or mat, such that the resulting duct insulation laminate may be packaged and stored as a roll of material. For example, the facing material may have a caliper (per ISO 534 testing) of less than approximately 0.8 mm, or approximately 0.3 mm to approximately 0.68 mm, or approximately 0.3 mm to approximately 0.4 mm. In one exemplary embodiment, the facing material has a Gurley static stiffness measure (per test method NEN 1842:1985 nl: Paper and board-determination of stiffness) of less than approximately 500 mg. The use of a thin, flexible facing material, as described above, laminated with a lofted insulation layer, provides a resulting insulating laminate that is flexible enough to be inserted into most standard-sized spiral duct pipes used in commercial and industrial HVAC applications.

In one exemplary embodiment, the facing is suitable for a fibrous insulation product. Facing materials that are suitable for fibrous insulation products include, but are not limited to, a nonwoven mat, web, or a veil. The facing may include a waterless, thin-film adhesive adhered thereto. The facing may include a fibrous web and a waterless, thin-film adhesive adhered to a major surface of the fibrous web. The fibrous web may be formed from fibers such as, but not limited to, glass fibers, mineral wool, rock wool, polymer fibers, synthetic fibers, and/or natural fibers. As used in this application, the term “natural fiber” is meant to indicate plant fibers extracted from any part of a plant, including, but not limited to, the stein, seeds, leaves, roots, or bast. Desirably, the fibrous web is formed of organic fibers such as rayon, polyethylene, polypropylene, nylon, polyester, and mixtures thereof. Continuous fibers and/or multi-component fibers such as bicomponent or tricomponent polymer fibers may also be utilized in forming the facing. The bicomponent fibers may be formed in a sheath-core arrangement in which the sheath is formed of first polymer fibers that substantially surround a core formed of second polymer fibers. Although the facing is preferably a non-woven web formed by conventional wet-laid processes, other materials such as point bonded, woven, and other non-woven materials such as needled, spunbonded, or meltblown webs may additionally or alternatively be used. A binder or combination of binders, flame-retardants, pigments, fillers, and/or other conventional additives may also be included in the facing. Optionally, the facing may be treated with a fungicide and/or bactericide either during or after manufacturing. Similarly, the waterless, thin-film adhesive may be heat bonded to a facing and subsequently applied to a fibrous insulation product.

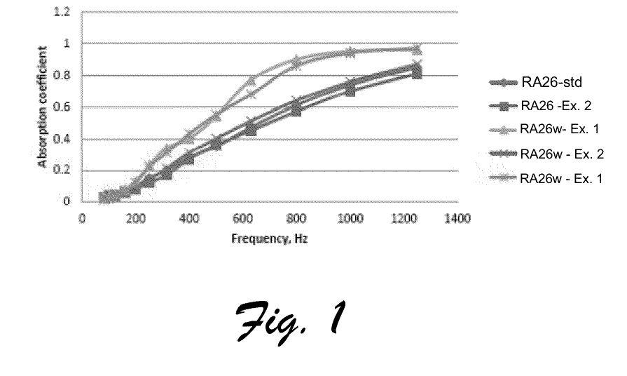

In an exemplary embodiment of the present application, the facing material includes a thin polyester blended veil formulated to improve sound absorption in lower frequency ranges of the noise spectrum (e.g., 200 Hz to 1250 Hz), for example, for enhanced noise suppression of an HVAC system. In some exemplary embodiments, facing materials with relatively low air permeability or porosity and relatively high square weight may be selected for enhanced sound absorption. In one exemplary embodiment, a duct insulation laminate formed from the Example 1 blended polyester veil, as described above, is adhered to a 1½ inch thick RA-26 fiberglass blanket. Acoustic testing of the duct insulation laminate, as illustrated in the table of FIG. 1, showed the duct insulation laminate demonstrated an absorption coefficient at frequencies of at least between 400 Hz and 1000 Hz, of at least 20% greater than an absorption coefficient of a 1½ inch thick RA-26 fiberglass blanket without the laminated facing. The testing also shows a significantly greater sound absorption than a 1½ inch thick RA-26 fiberglass blanket laminated with a veil (of Example 2 material) of a significantly greater porosity and significantly lower square weight.

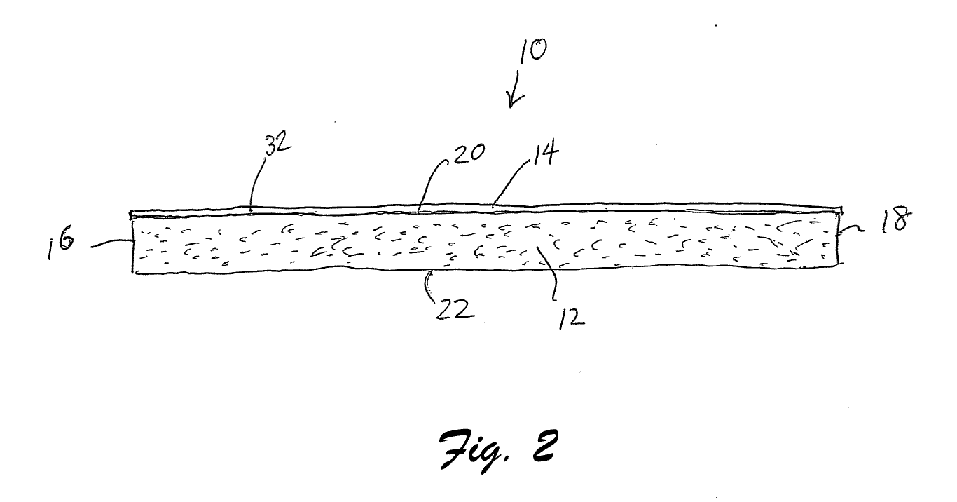

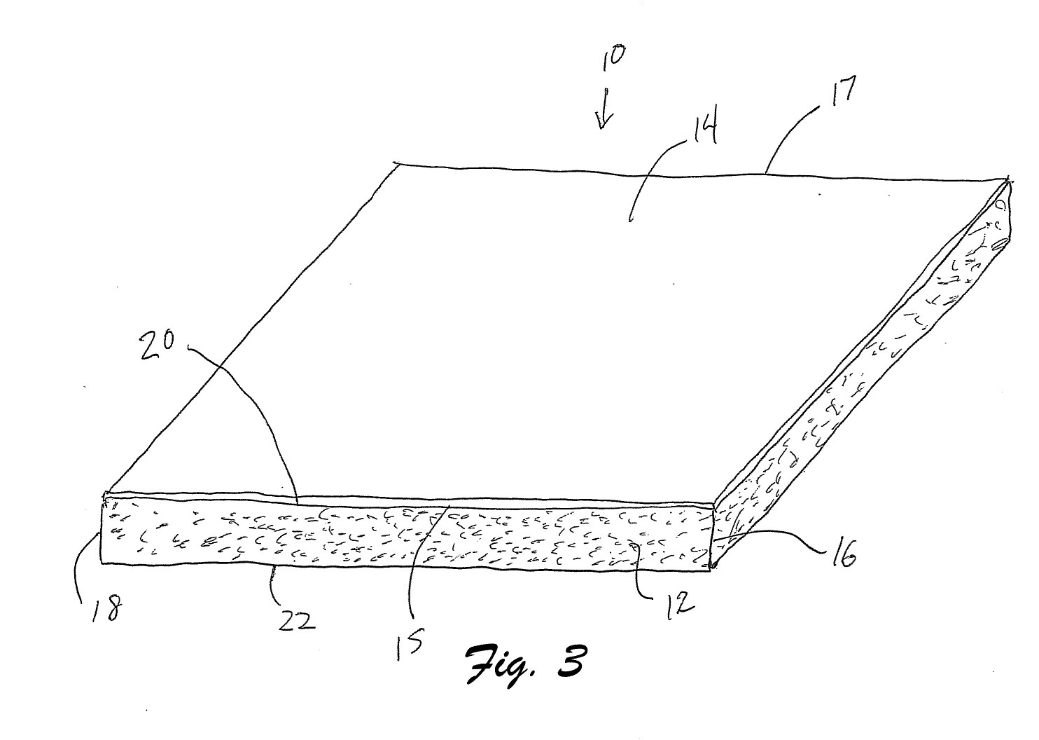

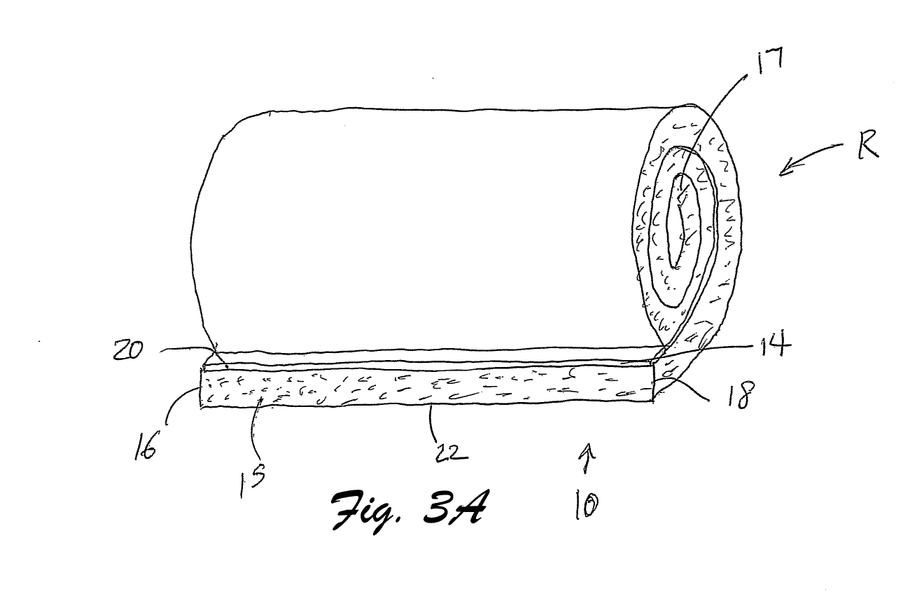

FIGS. 2 and 3 illustrate an exemplary embodiment of a duct insulation laminate 10. The illustrated duct insulation laminate 10 includes an insulation layer 12 and a facing 14. The insulation layer 12 may take a wide variety of different forms. In the illustrated embodiment, the insulation layer 12 is rectangular with a leading edge 15 spaced apart from a trailing edge 17 (see FIG. 3), and first and second lateral spaced apart edge surfaces 16, 18 (FIG. 2). However, the insulation layer 12 may have any shape to accommodate the desired application of the duct insulation laminate 10. For example, the leading and trailing edges 15, 17 of the insulation layer 12 may be disposed at an angle from perpendicular, for example, to facilitate winding of the insulation laminate 10 around a duct housing as an exterior wrap, as described in greater detail below. A first face surface 20 extends from the first lateral edge surface 16 to the second lateral edge surface 18. A second face surface 22 is opposed to and spaced apart from the first face surface 20 and also extends from the first lateral edge surface 16 to the second lateral edge surface 18.

The facing 14 is secured to or laminated with a first face surface 20 of the insulation layer 12. The facing 14 can be secured to the first face surface 20 in a wide variety of different ways. For example, the facing 14 may be secured to the first face surface 20 using an adhesive, such as, for example, polyethylene (PE), ethylene vinyl acetate (EVA), polylactic acid or polylactide (PLA), polycaptrolactam, polyurethane (PUR), thermoplastic polyester (PES), poly-propylene (PP), polyvinyl acetate (PVA), and poly vinyl alcohol (PVOH). Other arrangements for attaching the facing 14 to the first face surface 20 may additionally or alternatively be used, as described in greater detail below.

The facing 14 may take a wide variety of different forms. The facing 14 may be a single sheet of material or several stacked, overlapping, or adjacent (side-by-side) layers of material. The facing 14 may be made from a wide variety of different materials. For example, the facing 14 may comprise nonwoven fiberglass and polymeric media, woven fiberglass and polymeric media, sheathing materials, such as sheathing films made from polymeric materials, scrims, cloths, fabrics, or veils. The facing may be fire resistant, may provide a cleanable surface, may include an antimicrobial material, and/or may include recycled material (e.g., made from over 20% or over 55% recycled material, or some other predetermined amount). The facing may be porous. The facing material may be selected to reduce airflow resistance (as compared to the airflow resistance of the uncovered insulation layer 12).

The facing 14 may be disposed on the insulation layer 12 in a wide variety of different ways. In one exemplary embodiment, the facing 14 is adhered to the insulation layer 12. Any portion of the facing 14 can be adhered to any portion of the insulation layer. For example, the strips 26 are adhered to the second face surface 22, the facing portions 28 are adhered to the first and second lateral edge surfaces 16, 18 of the insulation layer 12, and/or the facing 14 is adhered to the first face surface 20. In one exemplary embodiment, the strips 26 are adhered to the second face surface 22, the facing portions 28 are not adhered to the first and second lateral edge surfaces 16, 18 of the insulation layer 12, and the facing 14 is adhered to the first face surface 20. Any portion or portions of the facing 14 can be adhered to any portion or portions of the insulation layer.

The facing 14 can be adhered to the insulation layer 12 in a wide variety of different ways. For example, the facing can be adhered to the insulation layer with an adhesive, by ultrasonic welding, or the facing can be fastened to the insulation layer by mechanical fasteners. A wide variety of different adhesives can be used to adhere the facing 14 to the insulation layer 12. For example, the adhesive can be a water base adhesive, a one part adhesive, a two part adhesive, a powder adhesive, a hot melt adhesive, thin film adhesives, a binder, such as a formaldehyde free binder and a spunbond hot melt adhesive web. Spunbond hot melt adhesive webs are available from Spunfab of Cuyahoga Falls, Ohio. The adhesive 32 may be applied in a wide variety of different ways. The adhesive may be applied to the insulation layer 12 and/or the facing 14, for example by spraying, rolling, brushing, etc. When a binder is used, the binder may be a binder that is part of the insulation layer 12 and/or the facing 14 and curing of the binder adheres the insulation layer 12 to the facing 14.

In one exemplary embodiment, the adhesive is a waterless, thin-film adhesive, such as a thermoplastic that is heat activated. In exemplary embodiments, the waterless, thin-film adhesive has a thickness less than or equal to about 60 microns, from about 6.0 to about 30.0 microns, or from about 10 microns to about 15 microns. The waterless, thin-film adhesive is applied to the facing material via the application of heat. For instance, the waterless, thin-film adhesive may be positioned on the facing and then adhered to the facing by heating the facing material with a hot plate or other suitable heating device (e.g., an oven). The facing material may similarly be adhered to the insulation layer 12 by heating the facing and the insulation layer to a temperature at or above the melting point of the waterless, thin-film adhesive for a time sufficient to adhere the facing to the insulation layer. Non-limiting examples of suitable adhesives include an ethylene copolymer, polyurethane, ethylene vinyl acetate (EVA), amorphous polyolefin, polyethylene, low density polyethylene (LDPE), cellophane, polyethylene terephthalate (PETP), polyvinyl chloride (PVC) nylons, polypropylene, polystyrene, polyamides, and cellulose acetate.

A wide variety of mechanical fastening arrangements may be used to fasten the facing 14 to the insulation layer 12. The mechanical fastening arrangements may be used in combination with or in lieu of adhesives, ultrasonic welding, and/or other types of bonding. Examples of mechanical fastening arrangements that can be used to connect the facing 14 to the insulation layer 12 include, but are not limited to, pinning, needling, sewing, and gripping or friction type fasteners. Any type of fastener that allows the facing 14 to be attached to the insulation layer 12 can be used.

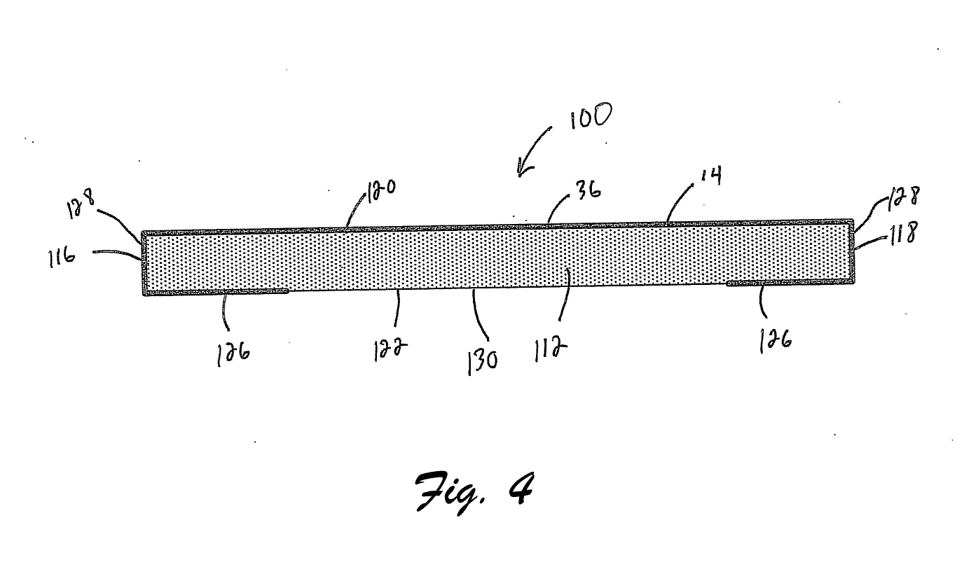

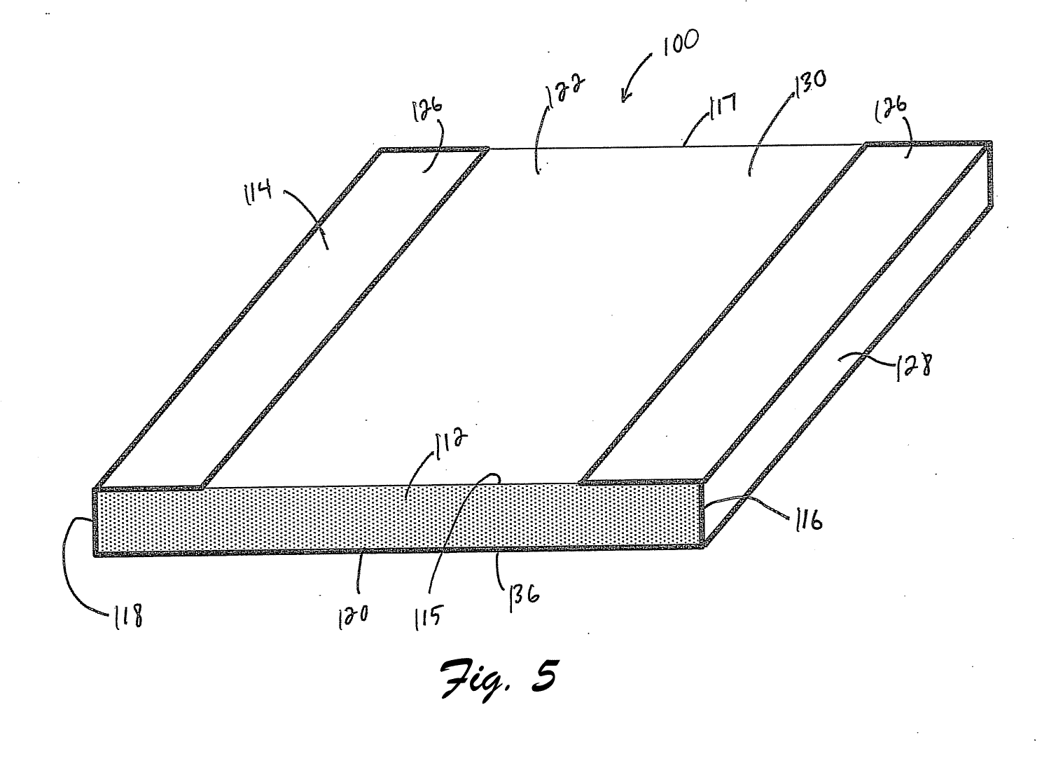

The facing 14 may additionally or alternatively be wrapped around one or more of the leading edge 15, trailing edge 17, and first and second lateral edge surfaces 16, 18. Exemplary embodiments of duct insulation laminates including facing wrapped around one or more edges of an insulation layer are described in copending U.S. Non-provisional patent application Ser. No. 13/764,920, filed on Feb. 12, 2013 and entitled DUCT LINER (the “'920 Application”), the entire disclosure of which is expressly incorporated by reference. FIGS. 4 and 5 illustrate one such duct insulation laminate 100, in which a facing 114 is disposed on a first face surface 120 of an insulation layer 112, such that the first face surface 120 is entirely covered by the facing 114. The facing 114 is also disposed on the first and second lateral edge surfaces 116, 118, such that the first and second edge surfaces are entirely covered by the facing. Two spaced apart strips 126 extend from the facing portions 128 that cover the first and second lateral edge surfaces 116, 118. The spaced apart strips 126 are disposed on and cover a portion of the second face surface 122 adjacent to the first and second lateral edge surfaces 116, 118. A portion 130 of the second face surface 122 between the strips 126 is not covered by the facing in the illustrated embodiment.

In the exemplary embodiment illustrated by FIGS. 2 and 3, the facing 14 is disposed on the first face surface 20, such that the first face surface is entirely covered by the facing 14. In other embodiments (not shown), portions of the first face surface may remain uncovered by the facing. For example, portions of the first face surface may be exposed through gaps, openings, or perforations in the facing. As another example (not shown), portions of the first face surface may instead be covered by a different material, such as, for example, sealants, fasteners, tapes, and mastics.

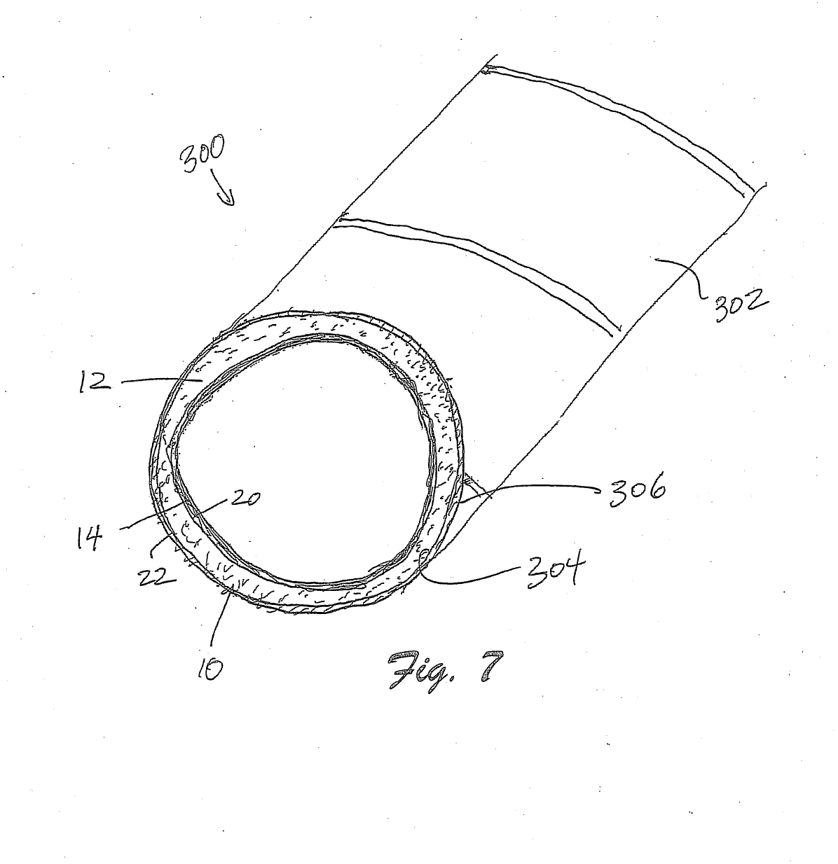

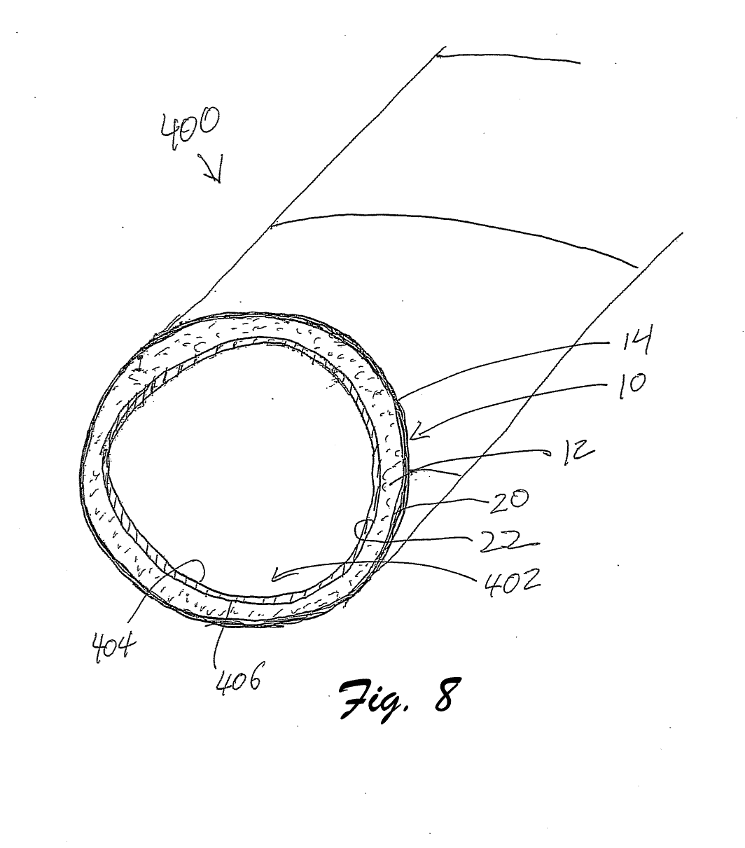

FIG. 3 illustrates the duct insulation laminate 10 in a rectangular configuration. This duct insulation laminate may be flexible for installation in (e.g., as a liner), as shown in FIG. 7, or around (e.g., as a wrap), as shown in FIG. 8, a metal duct assembly, such as, for example, a spiral duct assembly. In another example (not shown), the duct insulation may be installed in a double wall spiral duct assembly, as known in the art, between concentric inner and outer duct walls (typically spaced apart by spacers welded to the outer surface of the inner duct wall. To provide for sufficiently flexible duct insulation, the insulation layer 12 of the duct insulation laminate 10 may include a non-woven batt or blanket of lofted fiber material, such as, for example, fiberglass or polyester. Exemplary fiberglass blanket materials include a bonded blanket of short glass fibers, such as the blanket used in QuietR® rotary duct liner available from Owens Corning, or a bonded blanket of long glass fibers, such as the blanket used in the QuietR® textile duct liner available from Owens Corning. Other examples include RA series appliance insulation, available from Owens Corning (e.g., 1½ inch thick RA-26 insulation blanket). In the example illustrated by FIG. 3A, the duct insulation laminate 10 is flexible, which allows the insulation laminate to be rolled into a roll R. The illustrated roll has a width W. The width W can be selected to accommodate a wide variety of different applications. For example, the width W of the duct insulation laminate roll 200 may correspond to the interior or exterior width of a duct panel, perimeter of a duct half, or entire perimeter of a duct.

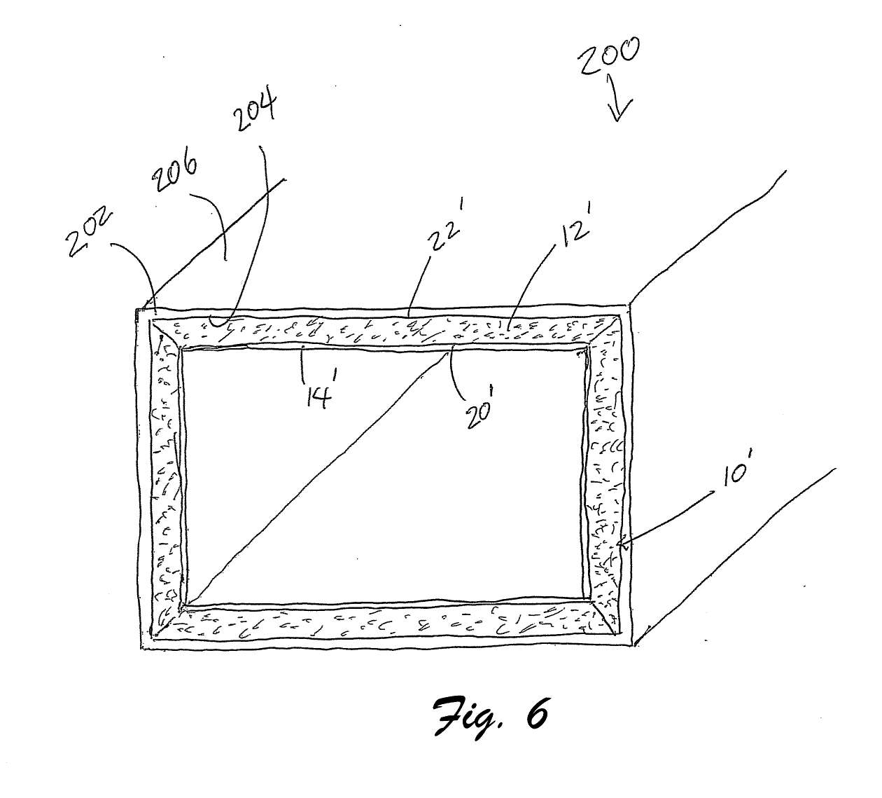

In another exemplary embodiment, the duct insulation laminate 10 may be rigid and may be used as a duct board with or without a metal duct. In one such exemplary embodiment, the insulation layer 12 may include organic and/or inorganic fibers in a thermosetting resin formed into flexible, semi-rigid, or rigid boards. The insulation layer 12 may be constructed from glass fibers such that the duct insulation laminate meets the physical property requirements of ASTM C 1071, Standard Specification for Thermal and Accoustical Insulation (Glass Fiber Duct Lining Material). Examples of duct board insulation layers for use in the insulation laminate include a resin-bonded fibrous glass board. FIG. 6 illustrates an exemplary rectangular duct assembly 200 having a rigid duct insulation laminate 10′ secured to an interior of the duct housing, as described in greater detail below, using methods described, for example, in the '920 Application.

As noted above, the insulation layer 12 may be made from a wide variety of different materials. The materials may include glass fibers as mentioned above and can also include a wide variety of other materials. Examples of materials that the insulation layer 12 can be made from include, but are not limited to, nonwoven fiberglass and polymeric media, woven fiberglass and polymeric media, foam, including plastic foam and rubber foam, honeycomb composites, mineral wool, rock wool, ceramic fibers, glass fibers, aerogels, vermiculite, calcium silicate, fiberglass matrix, polymeric fibers, synthetic fibers, natural fibers, composite pre-forms, cellulose, wood, cloth, fabric, plastic, and cork. The insulation layer may be fire resistant, may include an antimicrobial material, and/or may include recycled material (e.g., made from over 55% recycled material). As used in this application, the term “natural fiber” is meant to indicate plant fibers extracted from any part of a plant, including, but not limited to, the stein, seeds, leaves, roots, or bast. The insulation layer may be formed of organic fibers such as rayon, polyethylene, polypropylene, nylon, polyester, and mixtures thereof. Continuous fibers and/or multi-component fibers such as bicomponent or tricomponent polymer fibers may also be utilized in forming the insulation layer 12. The bicomponent fibers may be formed in a sheath-core arrangement in which the sheath is formed of first polymer fibers that substantially surround a core formed of second polymer fibers. The insulation layer 12 may be a non-woven web formed by conventional dry-laid processes or the insulation layer may be point bonded, woven, and other non-woven materials such as needled, spunbonded, or meltblown webs may be used. A binder, flame-retardants, pigments, and/or other conventional additives may also be included in the insulation layer 12. Optionally, the insulation layer 12 may be treated with a fungicide and/or bactericide either during or after manufacturing. Similarly, the waterless, thin-film adhesive may be heat bonded to a insulation layer 12 and subsequently applied to a fibrous insulation product. The insulation layer can be made from any material that provides the thermal and/or acoustical insulation properties required by the application.

When the insulation layer 12 is made from glass fibers, the insulation layer may be formed of matted glass fibers that are bonded together by a cured thermoset polymeric material. The manufacture of glass fiber insulation products may be carried out in a continuous process by fiberizing molten glass and immediately forming a fibrous glass batt on a moving conveyor. The glass may be melted in a tank (not shown) and supplied to a fiber forming device such as a fiberizing spinner. Non-limiting examples of glass fibers that may be utilized in the present invention are described in U.S. Pat. No. 6,527,014 to Aubourg; U.S. Pat. No. 5,932,499 to Xu et al.; U.S. Pat. No. 5,523,264 to Mattison; and U.S. Pat. No. 5,055,428 to Porter, the contents of which are expressly incorporated by reference in their entirety. The glass fibers, are sprayed with an aqueous binder composition. Although any conventional binder such as phenol-formaldehyde and urea-formaldehyde may be used, the binder is desirably a low formaldehyde binder composition, such as a polycarboxylic based binder, a polyaciylic acid glycerol (PAG) binder, or a polyaciylic acid triethanolamine (PAT binder). Suitable polycarboxy binder compositions for use in the instant invention include a polycarboxy polymer, a crosslinking agent, and, optionally, a catalyst. Such binders arc known for use in connection with rotary fiberglass insulation. Examples of such binder technology are found in U.S. Pat. Nos. 5,318,990 to Straus; 5,340,868 to Straus et al.; 5,661,213 to Arkens et al.; 6,274,661 to Chen et al.; 6,699,945 to Chen et al; and 6,884,849 to Chen et al., each of which is expressly incorporated entirely by reference. The binder may be present in an amount from about 2% to about 25% by weight of the total product, and preferably from about 5% to about 20% by weight of the total product, and most preferably from about 10% to about 18% by weight of the total product.

Many different methods may be used to make duct insulation laminates in accordance with the present application. Exemplary methods are described in the above incorporated '920 Application.

Referring to FIGS. 6 and 7, the duct insulation laminate 10′, 10 may be secured to an interior surface of a duct housing 202, 302 to form an insulated duct assembly 200, 300. The illustrated duct housings 202, 302 include an interior surface 204, 304 and an exterior surface 206, 306. In the illustrated exemplary embodiments, the duct insulation laminate 10′, 10 is oriented such that the facing 14′, 14 covering the first face surface 20′, 20 of the insulation layer 12′, 12 faces the interior cavity of the housing 200, 300. The second face surface 22′, 22 of the insulation layer 12′, 12 may, but need not, be secured directly to the interior surface 204, 304 of the duct housing 202, 302. The duct assembly 200, 300 may be formed from a wide variety of different assembly methods, examples of which are described in the above incorporated '920 Application.

Referring to FIG. 8, the duct insulation laminate 10 may be wrapped around and secured to an exterior surface of a cylindrical duct housing 402 to form an insulated duct assembly 400. The illustrated duct housing 402 includes an interior surface 404 and an exterior surface 406. In the illustrated exemplary embodiments, the duct insulation laminate 10 is oriented such that the facing 14 covering the first face surface 20 of the insulation layer 12 faces away from the exterior surface of the housing. The second face surface 22 of the insulation layer 12 may, but need not, be secured directly to the exterior surface 406 of the duct housing 402. The duct assembly 400 may be formed from a wide variety of different assembly methods, examples of which are described in the above incorporated '920 Application.

While the present invention has been illustrated by the description of embodiments thereof, and while the embodiments have been described in considerable detail, it is not the intention of the applicant to restrict or in any way limit the scope of the appended claims to such detail. Additional advantages and modifications will readily appear to those skilled in the art. Still further, while rectangular components have been shown and described herein, other geometries can be used including elliptical, polygonal (e.g., square, triangular, hexagonal, etc.) and other shapes can also be used. Therefore, the invention, in its broader aspects, is not limited to the specific details, the representative apparatus, and illustrative examples shown and described. Accordingly, departures can be made from such details without departing from the spirit or scope of the applicant's general inventive concept.

1. A duct insulation laminate comprising:
an insulation layer having a first edge surface, a second edge surface that is spaced apart from the first edge surface, a first face surface that extends from the first edge surface to the second edge surface, and a second face surface that is opposed to and spaced apart from the first face surface, wherein the second face surface extends from the first edge surface to the second edge surface; and
a facing attached to the first face surface, wherein the facing comprises a polyester blended non-woven veil defining an outermost exterior surface of the duct insulation laminate.

2. The duct insulation laminate of claim 1 wherein the polyester blended non-woven veil comprises boron-free E and E-CR glass reinforcement fibers.

3. The duct insulation laminate of claim 1 wherein the facing has a porosity of less than approximately 300 l/m²/s.

4. The duct insulation laminate of claim 1 wherein the facing has a caliper of less than approximately 0.8 mm.

5. The duct insulation laminate of claim 1 wherein the facing has a caliper of approximately 0.3 mm to approximately 0.4 mm.

6. The duct insulation laminate of claim 1 wherein the facing has a maximum Gurley static stiffness of approximately 500 mg.

7. The duct insulation laminate of claim 1 wherein the duct insulation laminate demonstrates a sound absorption coefficient from 400-1000 Hz of at least 20% greater than a corresponding sound absorption coefficient of the insulation layer without the facing.

8. The duct insulation laminate of claim 1 wherein the insulation layer is made from a fibrous material.

9. The duct insulation laminate of claim 1 wherein the insulation layer comprises a fiberglass blanket.

10. The duct insulation laminate of claim 1 wherein the insulation layer comprises a rigid fiberglass duct board.

11. The duct insulation laminate of claim 1 wherein the insulation layer is made from a material selected from the group consisting of foam, including plastic foam and rubber foam, honeycomb composites, rockwool, ceramic fibers, glass fibers, aerogels, vermiculite, calcium silicate, fiberglass matrix, polymeric fibers, composite pre-forms, cellulose, wood, and plastic.

12. The duct insulation laminate of claim 1 wherein the facing is adhered to the insulation layer.

13. The duct insulation laminate of claim 1 wherein the facing is adhered to the first and second edge surfaces of the insulation layer.

14. The duct insulation laminate of claim 1 wherein the facing is adhered to the insulation layer with an adhesive.

15. The duct insulation laminate of claim 14 wherein said adhesive is selected from the group consisting of formaldehyde free binder, water base adhesive, one part adhesive, two part adhesive, powder adhesive, hot melt adhesive, thin film adhesives, and a spunbond hot melt adhesive web.

16. The duct insulation laminate of claim 1 wherein the facing is adhered to the insulation layer by ultrasonic welding.

17. The duct insulation laminate of claim 1 wherein the facing is adhered to the insulation layer by mechanical fasteners.

18. The duct insulation laminate of claim 1 wherein the facing is a single sheet of material.

19. The duct insulation laminate of claim 1 wherein the facing comprises multiple sheets of material.

20. The duct insulation laminate of claim 1 wherein the facing is prefolded such that the facing includes a predefined central portion that covers the first face surface, a pair of predefined edge covering portions on opposite sides of the predefined central portion, and a pair of strips that are predefined and extending from the pair of predefined edge covering portions.

21. A duct assembly comprising:
a duct housing having an interior surface and an exterior surface; and
a duct insulation laminate secured to the interior surface of the duct housing, wherein the duct insulation laminate comprises:
an insulation layer having a first edge surface, a second edge surface that is spaced apart from the first edge surface, a first face surface that extends from the first edge surface to the second edge surface, and a second face surface that is opposed to and spaced apart from the first face surface, wherein the second face surface extends from the first edge surface to the second edge surface; and
a facing attached to the first face surface, wherein the facing comprises a polyester blended non-woven veil defining an outermost exterior surface of the duct insulation laminate;
wherein the duct insulation laminate is oriented such that the second face surface of the facing faces the interior surface of the housing.

22. A method of making a duct insulation laminate comprising:
providing an insulation layer having a first edge surface, a second edge surface that is spaced apart from the first edge surface, a first face surface that extends from the first edge surface to the second edge surface, and a second face surface that is opposed to and spaced apart from the first face surface, wherein the second face surface extends from the first edge surface to the second edge surface; and
attaching a facing to the first face surface of the insulation layer to define an outermost exterior surface of the duct insulation laminate, wherein the facing comprises a polyester blended non-woven veil defining an outermost exterior surface of the duct insulation laminate.

23. A duct insulation laminate comprising:
an insulation layer having a first edge surface, a second edge surface that is spaced apart from the first edge surface, a first face surface that extends from the first edge surface to the second edge surface, and a second face surface that is opposed to and spaced apart from the first face surface, wherein the second face surface extends from the first edge surface to the second edge surface; and
a facing attached to the first face surface;
wherein the duct insulation laminate demonstrates a sound absorption coefficient from 400-1000 Hz of at least 20% greater than a corresponding sound absorption coefficient of the insulation layer without the facing.
